(19) United States
(12) Patent Application Publication
(10) Pub. No.: US 2011/0267444 A1
(43) Pub. Date: Nov. 3, 2011

(54) ENDOSCOPE APPARATUS, METHOD, AND COMPUTER READABLE MEDIUM

(76) Inventor: Hiroshi YAMAGUCHI, (US)

(21) Appl. No.: 13/097,961

(22) Filed: Apr. 29, 2011

(30) Foreign Application Priority Data
Apr. 30, 2010 (JP) 2010-105704

(51) Int. Cl. H04N 7/18

(52) U.S. Cl. 348/65; 348/E07.085

(57) ABSTRACT

Provided is an endoscope apparatus that simultaneously displays a plurality of observation images, which are images for form observation or function observation of an organism. The endoscope apparatus comprises an image capturing section that captures a series of raw images, which are images of the organism; a movement detecting section that detects movement of the organism; a range setting section that sets ranges for extracting portions of the raw images respectively as the observation images, according to the movement of the organism detected by the movement detecting section; an extracting section that extracts images of the ranges set by the range setting section respectively from the raw images; and a display control section that displays the raw images together with the observation images extracted respectively therefrom.

### BACKGROUND

1. Technical Field

The present invention relates to an endoscope apparatus, a method, and a computer readable medium. The contents of the following Japanese patent application are incorporated herein by reference,
NO. 2010-105704 filed on Apr. 30, 2010.

2. Related Art

A technique is known for preventing blur in video of a video scope by detecting the blur amount in an image at a later timing with respect to an image at an earlier timing and then translating the image at the later timing according to the detected blur amount, as shown in Patent Document 1, for example. A blood-vessel endoscope apparatus is known that superimposes images blurred due to a heart beat onto each other in time sequence to show a still image, as shown in Patent Document 2, for example.
Patent Document 1: Japanese Patent Application Publication No. H06-285016
Patent Document 2: Japanese Patent Application Publication No. H11-168717

When an image at a later timing is translated in order to prevent image blur at a location that moves in the endoscope video, blur occurs at other locations that do not move. Furthermore, it is often the case that the movement of the image capturing target of an endoscope, such as an organism, cannot be simply translated. Therefore, when a plurality of images for form observation or function observation are sequentially captured at different timings and displayed simultaneously, simple extraction causes a positional skew in the extracted images, which results in am image that is difficult to base a diagnosis on.

### SUMMARY

In order to solve the above problems, according to a first aspect related to the innovations herein, provided is an endoscope apparatus that simultaneously displays a plurality of observation images, which are images for form observation or function observation of an organism. The endoscope apparatus comprises an image capturing section that captures a series of raw images, which are images of the organism; a movement detecting section that detects movement of the organism; a range setting section that sets ranges for extracting portions of the raw images respectively as the observation images, according to the movement of the organism detected by the movement detecting section; an extracting section that extracts images of the ranges set by the range setting section respectively from the raw images; and a display control section that displays the raw images together with the observation images extracted respectively therefrom.

The range setting section may set at least one of a position, a size, and an orientation of each image region extracted as an observation image, according to the movement of the organism detected by the movement detecting section.

the range setting section may include a position identifying section that identifies a position of a target location for the form observation or the function observation in image regions captured by the image capturing section, based on the movement of the organism; and a range determining section that determines the ranges to be extracted as the observation images based on the position identified by the position identifying section.

The position identifying section may identify a position of the target location in a plane orthogonal to an image capturing direction of the image capturing section, based on the movement of the organism. The range determining section may include a position determining section that determines a position of each image region to be extracted as an observation image, based on the position identified by the position identifying section.

The position identifying section may identify a position of the target location in an image capturing direction of the image capturing section, based on the movement of the organism. The range determining section may include a size determining section that determines a size of each image region to be extracted as an observation image, based on the position identified by the position identifying section.

The range setting section may include an angle identifying section that identifies an angle of rotation, around an image capturing direction of the image capturing section, of the target location for the form observation or the function observation; and an orientation determining section that determines an orientation of each image region to be extracted as an observation image, based on the angle identified by the angle identifying section.

The endoscope apparatus may further comprise a selection control section that selects which parameter, from among a position, a size, and an orientation of each image region to be extracted as an observation image, is to be used for setting the range of extraction by the range setting section, based on instructions from a user. The range setting section may set each range to be extracted as an observation image using the parameter or parameters selected by the selection control section.

The display control section may display the observation images to be larger than the image regions in the raw images extracted as the observation images.

The display control section may display each raw image with a mark indicating the range extracted as the observation image superimposed thereon.

The endoscope apparatus may further comprise a region identifying section that identifies a region in at least one of the raw images to be included in a range extracted as an observation image. The range setting section may identify a region in each raw image that corresponds to the region identified by the region identifying section, based on the movement of the organism detected by the movement detecting section, and set each range to be extracted as an observation image to be a range that includes at least the identified region.

The region identifying section may identify the region in at least one of the raw images to be included in a range extracted as an observation image, based on instructions from a user.

The endoscope apparatus may further comprise a condition storage section that stores conditions that must be satisfied by an image of the target location for the form observation or the function observation. The region identifying section may identify, as the region to be included in the range to be extracted as the observation image, a region in at least one of the raw images that satisfies the conditions stored in the condition storage section.

The movement detecting section may detect a phase of periodic movement of the organism. The range setting section may set the range to be extracted as the observation image according to the phase of the movement of the organism detected by the movement detecting section.

The endoscope apparatus may further comprise a movement characteristic storage section that stores movement characteristics in each of a plurality of regions captured by the image capturing section, in association with a phase of the movement of the organism. The range setting section may identify movement of a target location for the form observation or the function observation, based on the phase of the movement of the organism detected by the movement detecting section and the movement characteristics stored in the movement characteristic storage section, and set each range to be extracted as an observation image according to the identified movement.

The range setting section may identify movement of each of a plurality of the target locations, based on the phase of the movement of the organism detected by the movement detecting section and the movement characteristics stored in the movement characteristic storage section, and set a plurality of ranges to be extracted as observation images for each raw image. The extracting section may extract image regions of the plurality of ranges set by the range setting section from each raw image. The display control section may display each raw image together with the plurality of observation images extracted therefrom.

The movement detecting section may detect a phase of a heart beat of the organism. The range setting section may set the ranges to be extracted as the observation images according to the phase of the heart beat.

The summary clause does not necessarily describe all necessary features of the embodiments of the present invention. The present invention may also be a sub-combination of the features described above.

### BRIEF DESCRIPTION OF THE DRAWINGS

FIG. 1 shows an exemplary endoscope apparatus 10 according to an embodiment of the present invention.

FIG. 2 shows an exemplary block configuration of the image processing section 102.

FIG. 3 shows an exemplary block configuration of the range setting section 220.

FIG. 4 shows a setting example of extraction ranges.

FIG. 5 shows an exemplary screen of the display apparatus 140.

FIG. 6 shows other exemplary settings for the extraction ranges.

FIG. 7 shows other exemplary settings for the extraction ranges.

FIG. 8 shows an exemplary table of movement characteristics stored by the movement characteristic storage section 280.

FIG. 9 shows an exemplary process for extracting a plurality of observation images from a single raw image.

FIG. 10 shows another exemplary screen of the display apparatus 140.

FIG. 11 shows a process flow of the endoscope apparatus 10.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

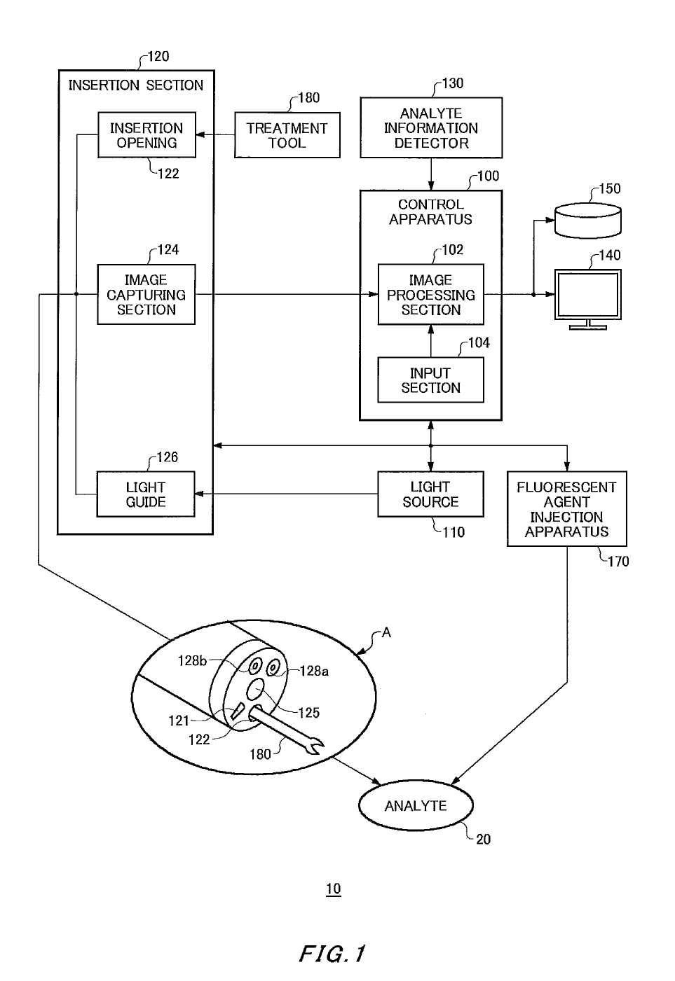

FIG. 1 shows an exemplary endoscope apparatus 10 according to an embodiment of the present invention. The endoscope apparatus 10 simultaneously displays a plurality of observation images, which are images for observing a form or a function of an organism.

Specifically, the endoscope apparatus 10 extracts the observation images from captured images of the organism and simultaneously shows the extracted images together with the captured images. Organism movement during image capturing can cause a positional shift of the target location for form observation or function observation, but the endoscope apparatus 10 shifts the extraction position of the observation images according to the organism movement, and can therefore generate observation images in which the location under observation is positioned in the center of the image region. As a result, the endoscope apparatus 10 can provide an observer such as a doctor, who is also the user, with a video for form observation or function observation in which the position of the target under observation appears static, along with a video showing the overall organism movement.

The organism in the present embodiment may be an internal organ such as the stomach, intestines, or the like inside a living creature such as a person, for example. The organism may be the outside or the inside lining of an internal organ. In the present embodiment, the location serving as the image capturing target of the endoscope apparatus 10 is referred to as an analyte 20. The endoscope apparatus 10 includes an insertion section 120, a light source 110, a control apparatus 100, an analyte information detector 130, a fluorescent agent injection apparatus 170, a recording apparatus 150, a display apparatus 140, and a treatment tool 180. An enlarged view of the tip of the insertion section 120 is shown in section A of FIG. 1.

The insertion section 120 includes an insertion opening 122, an image capturing section 124, and a light guide 126. The tip of the insertion section 120 includes an objective lens 125 as a portion of the image capturing section 124. The tip includes an irradiating section 128a and an irradiating section 128b as a portion of the light guide 126. The irradiating section 128a and the irradiating section 128b may each include an objective lens for light emission. The irradiating section 128a and the irradiating section 128b can be referred to collectively as the irradiating section 128. The tip also includes a nozzle 121.

The insertion section 120 is inserted into the organism. A treatment tool 180, such as forceps, for treating the analyte 20 is inserted into the insertion opening 122. The insertion opening 122 guides the treatment tool 180 inserted thereto to the tip. The treatment tool 180 can have a variety of tip shapes. The nozzle 121 discharges water or air toward the analyte 20.

The light guide 126 guides the light emitted by the light source 110 to the irradiating section 128. The light guide 126 can be realized using optical fiber, for example. The irradiating section 128 emits the light guided by the light guide 126 toward the analyte 20. The image capturing section 124 receives the light returning from the analyte 20 via the objective lens 125 to capture an image of the analyte 20.

The image capturing section 124 can capture visible light images of the analyte 20 using visible light. When capturing visible light images of the analyte 20, the light source 110 emits visible light. Specifically, the light source 110 emits illumination light that is substantially white light. The illumination light includes light in the red wavelength region, the green wavelength region, and the blue wavelength region, for example. The illumination light emitted by the light source 110 is emitted toward the analyte 20 from the irradiating section 128a via the light guide 126. The objective lens 125 receives returned light in the visible wavelength region, which is light resulting from the analyte 20 reflecting and scattering the illumination light. The image capturing section 124 captures a visible light image using the returned light in the visible wavelength region from the analyte 20.

The image capturing section 124 can capture luminescent light images using luminescent light from the analyte 20. Fluorescent and phosphorescent light are included in the scope of the luminescent light, which is an example of returned light from the analyte 20. Furthermore, in addition to photoluminescence caused by excitation light or the like, the luminescent light can result from chemical luminescence, triboluminescence, or thermoluminescence. In the description of the present embodiment, the endoscope apparatus 10 captures a fluorescent light image as an example of the luminescent light image, using fluorescent light generated by photoluminescence.

When capturing a fluorescent light image of the analyte 20, the light source 110 generates excitation light. The excitation light generated by the light source 110 is emitted toward the analyte 20 from the irradiating section 128b, via the light guide 126. A fluorescent substance in the analyte 20 is excited by the excitation light, and therefore emits fluorescent light. The image capturing section 124 captures the fluorescent light image of the analyte 20 using the fluorescent returned light. As shown in FIG. 1, the irradiating section 128a and the irradiating section 128b may be provided at different positions on the tip, but can instead be provided at the same position on the insertion section 120 to function as an irradiating section providing both illumination light and excitation light.

The fluorescent substance is an example of a luminescent substance. The fluorescent substance may be injected to the analyte 20 from the outside. The fluorescent substance may be indo cyanine green (ICG), for example. The fluorescent agent injection apparatus 170 may inject the ICG into the blood vessels of an organism using an intravenous injection. The amount of ICG that the fluorescent agent injection apparatus 170 injects into the analyte 20 is controlled by the control apparatus 100 to maintain a substantially constant concentration of ICG in the organism. The ICG is excited by infrared rays with a wavelength of 780 nm, for example, and generates fluorescent light whose primary spectrum is in a wavelength band of 830 nm. The image capturing section 124 captures the fluorescent light image of the analyte 20 using the fluorescent light generated by the ICG.

The fluorescent substance can be a substance other than ICG. If structural components, such as cells, of the analyte 20 already contain a fluorescent substance, the image capturing section 124 may capture the fluorescent light image of the analyte 20 using the organism's own fluorescent light as the returned light.

The image capturing section 124 may include a light receiving element array in which a plurality of blue light receiving sections that selectively receive light in the blue wavelength region, a plurality of green light receiving sections that selectively receive light in the green wavelength region, and a plurality of red light receiving sections that selectively receive light in the red wavelength region are arranged two-dimensionally. The image capturing section 124 can generate the visible light images using the blue light receiving elements, the green light receiving elements, and the red light receiving elements. In addition to the blue light receiving elements, the green light receiving elements, and the red light receiving elements, the image capturing section 124 may include a plurality of fluorescent light receiving elements that selectively receive light in the wavelength region of fluorescent light. By including the fluorescent light receiving elements in the light receiving element array, the image capturing section 124 can capture fluorescent images at the same time as the visible light images and with the same field of vision as the visible light images. Each light receiving element may be an image capturing element, such as a CCD or a CMOS.

The image capturing section 124 may include a visible light receiving element array in which the blue light receiving elements, green light receiving elements, and red light receiving elements are arranged two-dimensionally, and a fluorescent light receiving element array in which the fluorescent light receiving elements are arranged two-dimensionally. In this case, the image capturing section 124 may include in addition to the objective lens 125, as the image capturing optical system, a splitting optical system that splits the returned light from the analyte 20 passed by the objective lens 125 into two separate optical paths for the visible light and the fluorescent light, and respectively guides these two types of light to the visible light receiving elements and the fluorescent light receiving elements. With this configuration, the visible light images and fluorescent light images can be captured at the same timings and with the same field of vision. The splitting optical system may be a dichroic mirror, a dichroic prism, or the like.

The image capturing section 124 may have a divided configuration in which the blue light receiving elements are arranged two-dimensionally in a blue light receiving element array, the green light receiving elements are arranged two-dimensionally in a green light receiving element array, and the red light receiving elements are arranged two-dimensionally in a red light receiving element array. In this case, a splitting optical system may also be included to split the light in the blue wavelength region, the light in the green wavelength region, and the light in the red wavelength region into different optical paths and respectively guide these three types of light to the blue light receiving element array, the green light receiving element array, and the red light receiving element array.

If at least one of the plurality of blue light receiving elements, the plurality of green light receiving elements, and the plurality of red light receiving elements is substantially sensitive to fluorescent light, these light receiving elements can also be used as the fluorescent light receiving elements. For example, if the red light receiving elements are substantially sensitive to the fluorescent light from the ICG, visible light images and fluorescent light images can both be captured using a single visible light receiving element array. In this case, the analyte 20 is irradiated while switching the light from the irradiating section 128 over time between the illumination light and the excitation light. The image capturing section 124 can capture visible light images as a result of each light receiving element receiving the returned light when the illumination light is emitted and capture fluorescent light images as a result of the red light receiving elements receiving the fluorescent light in the returned light when the excitation light is emitted.

The image capturing section 124 is not limited to using returned light from the analyte 20, and can use a variety of methods to capture images of the analyte 20. For example, the image capturing section 124 can capture an image of the analyte 20 using electromagnetic radiation, such as X-rays or y rays, or particle rays such as alpha rays. The image capturing section 124 may capture the image of the analyte 20 using sound waves, electric waves, or electromagnetic waves with a variety of wavelengths.

In the present embodiment, the images of the analyte 20 captured by the image capturing section 124 are referred to as “raw images.” The image capturing section 124 captures a series of raw images using visible light, fluorescent light, radiation, electromagnetic waves, sound waves, or the like.

The control apparatus 100 includes an image processing section 102 and an input section 104. The image processing section 102 processes the raw images captured by the image capturing section 124, and outputs the processed images to the outside. For example, the image processing section 102 may output the processed images to at least one of the recording apparatus 150 and the display apparatus 140. Specifically, the image processing section 102 generates a video from a plurality of raw images captured by the image capturing section 124, and outputs the video to at least one of the display apparatus 140 and the recording apparatus 150. The image processing section 102 may output the video to at least one of the display apparatus 140 and the recording apparatus 150 via a communication network such as the Internet.

The image processing section 102 extracts observation images from the raw images captured by the image capturing section 124. The image processing section 102 dynamically sets the extraction range for the observation images based on the organism movement. Specifically, the image processing section 102 dynamically sets at least one of the position, size, and orientation for extracting the observation images.

The organism movement may include physiological periodic organism movement, such as a heart beat, respiration, trembling of organs, or the like. Organism movement such as a heart beat or respiration are detected directly or indirectly by the analyte information detector 130 outside the control apparatus 100, and the analyte information detector 130 supplies the image processing section 102 with an organism information signal indicating organism movement.

In the present embodiment, the analyte information detector 130 is attached to the organism. The analyte information detector 130 may detect an electrocardiographic signal indicating the heart beat. The analyte information detector 130 may detect respiration or the like of the organism. For example, the analyte information detector 130 may be attached to the mouth of the organism to detect a change over time in at least one of the amount of exhalation and the amount of inhalation, and may supply the image processing section 102 with the detection results as a respiration signal. As another example, the analyte information detector 130 may include a transmitter fixed at a location that is displaced by organism movement and a receiver placed outside the organism. The strength of the signal from the transmitter detected by the receiver indicates the displacement of the transmitter with respect to the receiver. The image processing section 102 may acquire from the receiver, as the organism information signal indicating organism movement, the signal strength received by the receiver. The receiver may be provided in the insertion section 120, on the tip thereof for example.

The image processing section 102 outputs the observation images to the outside, along with the raw images captured by the image capturing section 124. The image processing section 102 generates the observation images from the images captured in series by the image capturing section 124. The image processing section 102 outputs, to the outside, a moving image including the raw images captured in series and observation images extracted from the raw images.

Instructions are input to the input section 104 by a user. For example, an observer may input to the input section 104 instructions indicating which of the position, size, and orientation for extracting the observation images is to be dynamically set. The image processing section 102 dynamically sets at least one of the position, size, and orientation for extracting the observation images, based on the instructions input to the input section 104. Other instructions may be input to the input section 104, such as instructions for controlling the orientation of the tip of the insertion section 120 or instructions for controlling other image processing by the image processing section 102.

The display apparatus 140 displays the images processed by the image processing section 102. The recording apparatus 150 records the images processed by the image processing section 102 in a non-volatile recording medium. For example, the recording apparatus 150 may store the images in a magnetic recording medium such as a hard disk or in an optical recording medium such as an optical disk.

The endoscope apparatus 10 described above can provide an observer with an overall video including movement, together with videos for form observation or function observation in which image blur at the location under observation is decreased. The observer can carefully observe the location under observation using the video for form observation or function observation. At the same time, the observer can see a video that correctly shows movement of the analyte 20 with respect to the insertion section 120, by using the overall video. In other words, the observer is provided with an overall video in which locations moving relative to the insertion section 120 appear to move and locations that do not move relative to the insertion section 120 appear still. Accordingly, the observer can continue manipulating the endoscope without feeling disoriented. For example, while monitoring the overall video, the observer can accurately apply the treatment tool 180 or the like to the desired location and accurately orient the tip of the insertion section 120 toward the desired location.

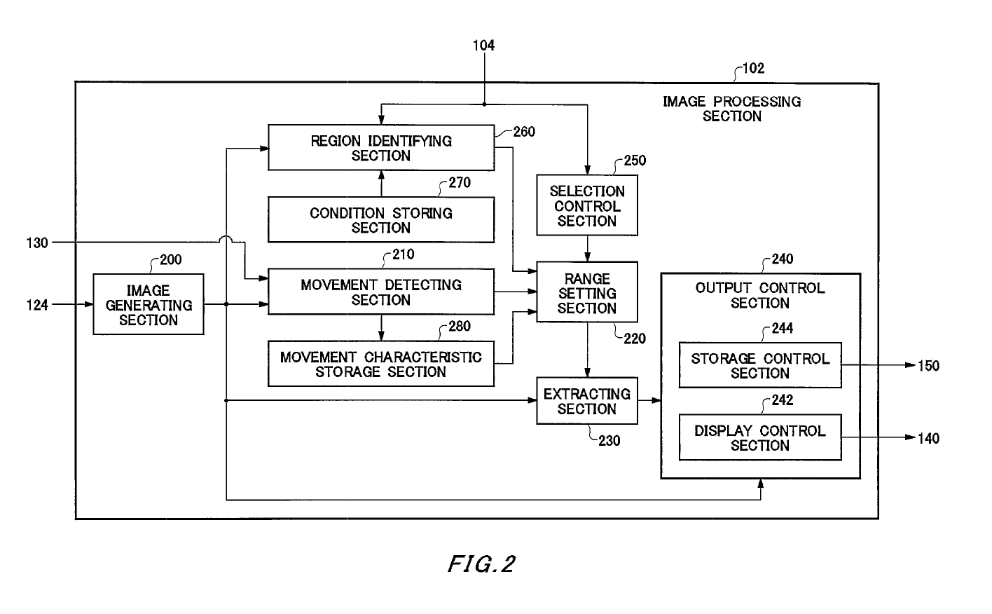

FIG. 2 shows an exemplary block configuration of the image processing section 102. The image processing section 102 includes an image generating section 200, a movement detecting section 210, a range setting section 220, an extracting section 230, an output control section 240, a selection control section 250, a region identifying section 260, and a condition storage section 270. The output control section 240 includes a storage control section 244 and a display control section 242.

The image generating section 200 acquires image capture signals of the raw images from the image capturing section 124. The movement detecting section 210 detects the organism movement. The range setting section 220 sets portions of the raw images to be extracted as the observation images, according to the organism movement detected by the movement detecting section 210.

The movement detecting section 210 may detect the movement of the analyte 20 based on the image content of the raw images. For example, the movement detecting section 210 may detect movement of the analyte 20 from the raw images, by using image analysis such as object extraction.

When the movement of the analyte 20 is caused by organism movement such as a heart beat or respiration, the movement of the analyte 20 correlates with this organism movement. When there is a correlation between movement of the analyte 20 and organism movement, the movement detecting section 210 may detect information indicating this organism movement.

Specifically, the movement detecting section 210 may acquire the organism information signal from the analyte information detector 130. If the organism information signal is an electrocardiographic signal, the movement detecting section 210 can detect the phase of the heart beat of the organism as the organism movement. The range setting section 220 sets the ranges to be extracted as the observation images, according to the phase of the heart beat. If the organism information signal is a respiration signal, the movement detecting section 210 can detect the phase of the respiration of the organism as the organism movement. The range setting section 220 then sets the ranges to be extracted as the observation images according to the phase of the respiration. In this way, the movement detecting section 210 may detect the phase of the periodic organism movement. The range setting section 220 can set the ranges to be extracted as the observation images according to the phase of the organism movement detected by the movement detecting section 210.

The extracting section 230 extracts an image of the range set by the range setting section 220 from each raw image. The display control section 242 displays the raw images together with the observation images extracted therefrom. Specifically, the display control section 242 displays the raw images together with the observation images extracted therefrom in the display apparatus 140. The storage control section 244 stores the raw images in association with the observation images extracted therefrom. Specifically, the storage control section 244 stores the raw images in association with the observation images extracted therefrom in the recording apparatus 150. In this way, the output control section 240 outputs the raw images in association with the observation images extracted therefrom.

The movement characteristic storage section 280 stores movement characteristics in each of the regions captured by the image capturing section 124, in association with the phase of the organism movement. The range setting section 220 identifies movement of a target location for the form observation or the function observation, based on the phase of the organism movement detected by the movement detecting section 210 and the movement characteristics stored by the movement characteristic storage section 280. The range setting section 220 sets the ranges to be extracted as the observation images according to the identified movement. As a result, even when the movement direction is different in each region, for example, the extraction range can be shifted in the appropriate direction according to the movement direction of the location serving as the extraction target. In the description of the present embodiment, the location that is the target of the form observation or function observation may be referred to simply as the “target location.”

The range setting section 220 can set the extraction range for each of a plurality of target locations. In this case, the range setting section 220 identifies the movement of each target location based on the phase of the organism movement detected by the movement detecting section 210 and the movement characteristics stored in the movement characteristic storage section 280. The range setting section 220 sets a plurality of ranges to be extracted as the observation images, according to the identified movements. The extracting section 230 extracts images of the regions set by the range setting section 220 from each of the raw images. The display control section 242 displays each raw image together with the plurality of observation images extracted therefrom. The storage control section 244 stores each raw image in association with the plurality of observation images extracted therefrom.

The parameters for determining the extraction ranges may include position, size, and orientation. Specifically, the range setting section 220 sets at least one of the position, size, and orientation of each image region to be extracted as an observation image, according to the organism movement detected by the movement detecting section 210. The parameter for defining the position of the extraction range may be the central position of the extraction region in the x-y plane. The parameter for defining the size of the extraction range may be at least one of an x-direction width and a y-direction width centered on the central position of the extraction range. The parameter for defining the orientation of the extraction range may be an angle of rotation around the central position of the extraction range having a predetermined shape.

The selection control section 250 selects, based on instructions from the observer, the extraction ranges to be set by the range setting section 220 using parameters including at least one of the position, size, and orientation of the image ranges to be extracted as the observation images. Specifically, the observer inputs information indicating the parameters to be changed when setting the extraction ranges into the control apparatus 100 via the input section 104. The selection control section 250 selects the parameters to be changed based on the instructions from the observer. The range setting section 220 sets the extraction ranges of the observation images using the parameters selected by the selection control section 250. Therefore, the range setting section 220 can set the extraction ranges while fixing one or more parameters that the observer judges should not be changed and changing a combination of one or more parameters that the observer judges should be changed.

The region identifying section 260 identifies a region in at least one of the raw images to be included in an observation image extraction range. For example, the region identifying section 260 may identify, based on instructions from the observer, a region in at least one of the raw images to be included in an observation image extraction range. The observer may designate a region in which an image of the range to be extracted as an observation image is captured, by moving a cursor on a raw image, for example. The range setting section 220 identifies the region corresponding to the region identified by the region identifying section 260, in each of the raw images, based on the organism movement detected by the movement detecting section 210. The range setting section 220 sets the observation image extraction ranges to be ranges that include at least the identified regions. As a result, the observer can designate a region of interest, such as a tumor, for form observation or function observation.

The observation image extraction ranges may be designated using the treatment tool 180, which may be forceps. For example, the observer may manipulate the treatment tool 180 while viewing the overall video generated from the raw images, and position the tip of the treatment tool 180 within the overall video region near the target location. Then, with the tip of the treatment tool 180 positioned near the target location, the use may provide instructions to set the region to be extracted, via the input section 104. The region identifying section 260 identifies the tip of the treatment tool 180 in the raw images using image recognition or the like, based on the image content of the raw images, and sets the region around the tip of the treatment tool 180 as the region to be included in the extraction range. As a result, the observer can designate the target location for form observation or function observation, without performing a complicated operation.

The location for form observation or function observation may be set according to image recognition by the image processing section 102. For example, the condition storage section 270 may store conditions to be fulfilled by the image of the target location for form observation or function observation. The region identifying section 260 identifies a region that fulfills the conditions stored in the condition storage section, for at least one of the raw images, as a region to be included in the observation image extraction range. The conditions stored by the condition storage section 270 may include image feature values or the like. The image feature values may include at least one of a color feature value and a shape feature value, for example. The region identifying section 260 determines the target location based on the image content of the raw images, and therefore the user target location can be designated without the user performing a complicated operation. Furthermore, the region identifying section 260 can automatically provide the user with potential regions for a target location, thereby decreasing the chance that the observer will overlook a location that should be a target location.

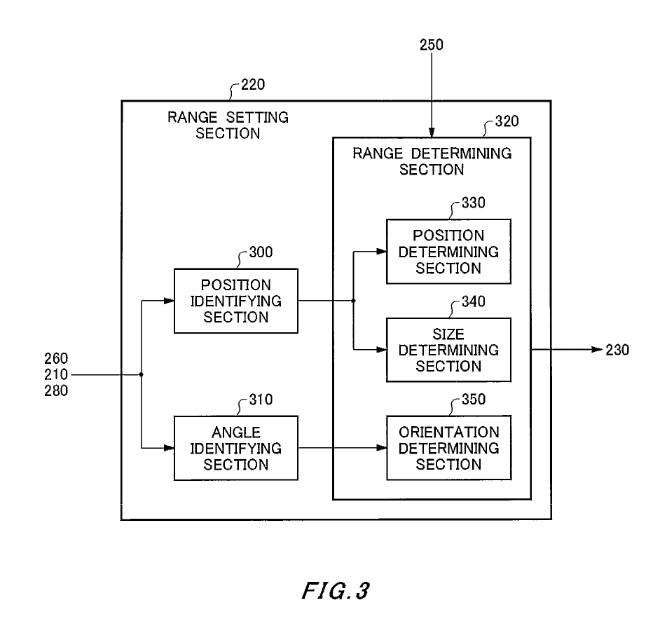

FIG. 3 shows an exemplary block configuration of the range setting section 220. The range setting section 220 includes a position identifying section 300, an angle identifying section 310, and a range determining section 320. The range determining section 320 includes a position determining section 330, a size determining section 340, and an orientation determining section 350.

The position identifying section 300 identifies the positions of a target location for form observation or function observation in the image regions captured by the image capturing section 124, based on the organism movement. The range determining section 320 determines the observation image extraction ranges based on the positions identified by the position identifying section 300.

Specifically, the position identifying section 300 determines the position of the target location in real space. More specifically, the position identifying section 300 identifies the position of the target location in a plane orthogonal to the image capturing direction of the image capturing section 124, based on the organism movement. The position determining section 330 then determines the position of the image region to be extracted as the observation image, based on the position identified by the position identifying section 300. When the target location moves within the plane orthogonal to the image capturing direction, the movement of the target location can be tracked by shifting the extraction range in the raw images.

The position identifying section 300 may identify the position of the target location in the direction of the image capturing of the image capturing section 124, based on the organism movement. The size determining section 340 determines the size of the image region to be extracted as the observation image, based on the position identified by the position identifying section 300. When the target location moves in the image capturing direction, the movement of the target location can be tracked by changing the size of the extraction range.

The angle identifying section 310 identifies the angle by which the target location for form observation or function observation rotates around the image capturing direction of the image capturing section 124, based on the organism movement. The orientation determining section 350 determines the orientation of the image region to be extracted as the observation image based on the angle identified by the angle identifying section 310. When the target location rotates around the optical axis of the objective lens 125, the extraction range can be rotated to track the rotation of the target location.

The range determining section 320 can determine the extraction range according to the parameters selected by the selection control section 250. For example, when the position of the image region to be extracted is set as the variable parameter of the extraction range, the position determining section 330 controls the central position of the extraction range. When the size of the image region to be extracted is set as the variable parameter of the extraction range, the position determining section 330 controls the size of the extraction range. When the orientation of the image region to be extracted is set as the variable parameter of the extraction range, the position determining section 330 controls the orientation of an extraction frame that determines the outline of the extraction range.

Information indicating the position determined by the position determining section 330, the size determined by the size determining section 340, and the orientation determined by the orientation determining section 350 are supplied to the extracting section 230. The extracting section 230 extracts, from the raw image, the range defined by the information supplied from the range determining section 320. In this way, the range setting section 220 can suitably set the extraction ranges according the movement characteristics of the target location.

The function of the control apparatus 100 may be realized by a computer. Specifically, by installing a program implementing the function of the control apparatus 100 in a computer, the computer may function as the image generating section 200, the movement detecting section 210, each component of the range setting section 220, the extracting section 230, each component of the output control section 240, the selection control section 250, the region identifying section 260, and the condition storage section 270. This program may be stored in a computer readable recording medium such as a CD-ROM or hard disk, and may be provided to the computer by having the computer read the program from the recording medium. The program may be provided to the computer via a network.

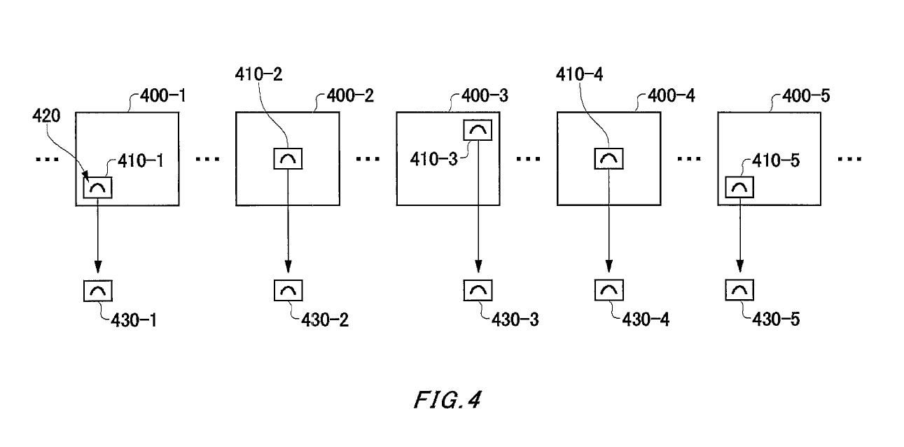

FIG. 4 shows a setting example of extraction ranges. Raw images 400-1 to 400-5 are captured by the image capturing section 124 at different timings. The raw images 400-1 to 400-5 may be referred to collectively as the “raw images 400.”

The raw image 400-1 includes a target location 420 for form observation or function observation. The position determining section 330 shifts the position of extraction frames 410-1 to 410-5 according to the positions identified by the position identifying section 300. The extracting section 230 extracts the partial images in the shifted extraction frames 410-1 to 410-5 from the corresponding raw images 400. As a result, observation images 430-1 to 430-5 are generated to have the target location 420 substantially in the centers thereof.

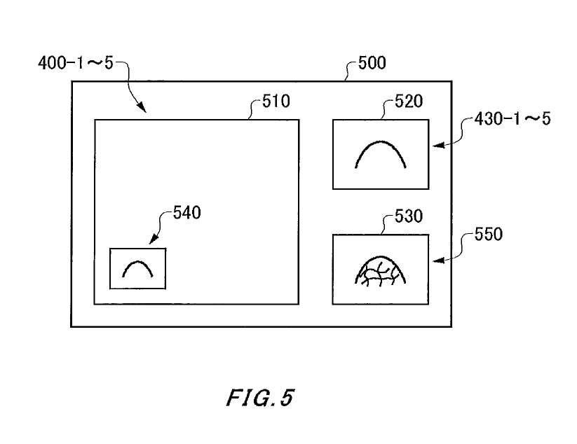

FIG. 5 shows an exemplary screen of the display apparatus 140. The display control section 242 switches the display in the display area 510 on the screen 500 of the display apparatus 140 sequentially among the raw images 400. The display control section 242 switches the display in the display area 520 on the screen 500 of the display apparatus 140 sequentially among the observation images 430.

When the observation images 430 are sequentially displayed on the display area 520 of the display apparatus 140, it appears to the observer that the position of the target location 420 is fixed. Therefore, the observer can carefully observe the target location 420. On the other hand, when the raw images 400 are sequentially played in series on the display area 510 of the display apparatus 140, locations that are still with respect to the insertion section 120 appear still on the screen and locations that move with respect to the insertion section 120 appear to move on the screen. Therefore, while observing the video of the raw images 400 displayed in the display area 510, the observer can manipulate the endoscope without feeling disoriented.

The display control section 242 displays the observation image 430-1 to be larger than the image region in the raw image 400-1 extracted as the observation image. The observation images 430 displayed in the display area 520 are enlarged to be bigger than the extraction regions and show the target location 420 in a substantially still state, and therefore the observer can very easily see the target location 420.

The display control section 242 superimposes a mark 540, which shows the extraction frame 410-1 of the raw image 400-1, on the raw image 400-1 displayed in the display apparatus 140. As a result, the display area 510 displays the mark 540 superimposed on the raw image 400-1. In this way, the display control section 242 displays each raw image with a mark 540 superimposed thereon that shows the observation image extraction range. As a result, the observer can easily recognize where the observation image 430-1 is positioned on the raw image 400-1.

The display control section 242 displays fluorescent observation images 550 extracted from fluorescent images in the display area 530 of the display apparatus 140. If the fluorescent images are captured by the image capturing section 124 at the same timings and with the same filed of vision as the raw images 400, the extracting section 230 generates the fluorescent observation images 550 by extracting, from the fluorescent images, the regions of the extraction ranges set in the raw images 400 by the range setting section 220.

If the fluorescent images and the raw images 400 are captured at different timings, the range setting section 220 sets the extraction ranges in the raw fluorescent images based on the organism movement at the timings at which the fluorescent images were captured. The extracting section 230 then generates the fluorescent observation images 550 by extracting the images of the set extraction ranges from the fluorescent images. The display control section 242 may display in the display area 530 the fluorescent observation image 550 extracted from the fluorescent image captured closest to the timing at which the raw image 400-1 was captured. As a result, the observer can be provided with an observation image in which the 420 appears still, along with the video of the raw images showing movement and the observation images in which the target location appears still.

FIG. 5 is used to describe a specific example of the display control by the display control section 242, but the display control of the display control section 242 is not limited to this. For example, the storage control section 244 may store the observation images 430 and the fluorescent observation image 550 in the recording apparatus 150 in association with the raw images 400 in order to display the raw images 400, observation images 430, and fluorescent observation image 550 in another manner.

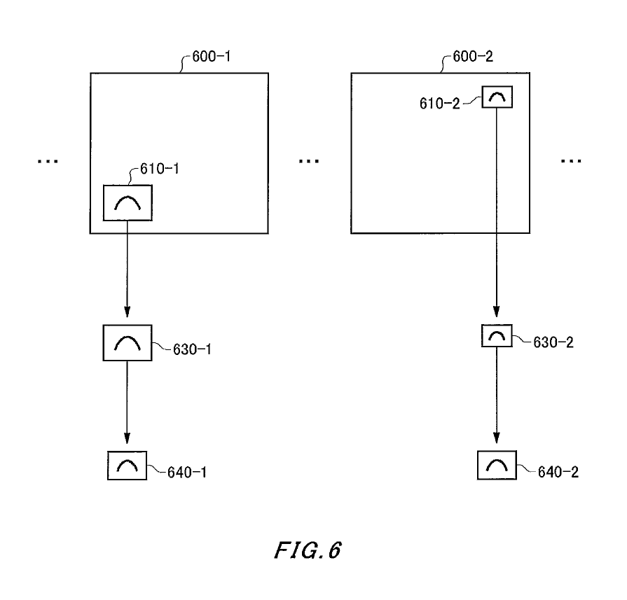

FIG. 6 shows other exemplary settings for the extraction ranges. Here, the target location appears larger in the raw image 600-1 than in the raw image 600-2. This change over time of the size of the target location image can be caused by the target location moving in the direction of the optical axis of the objective lens 125, for example. The size determining section 340 sets the size of the extraction frame 610-2 in the raw image 600-2 to be less than the size of the extraction frame 610-1 set for the raw image 600-1, based on the position of the target location identified by the position identifying section 300. In the example of FIG. 6, the central position of the target location shifts in a plane orthogonal to the optical axis as well, and the position determining section 330 determines the position of the extraction frame 610-2 to be shifted from the position of the extraction frame 610-1, based on the position of the target location identified by the position identifying section 300.

The extracting section 230 extracts the region in the extraction frame 610-1 from the raw image 600-1 to generate the observation image 630-1. The extracting section 230 extracts the region in the extraction frame 610-2 from the raw image 600-2 to generate the observation image 630-2. The display control section 242 generates observation images 640-1 and 640-2 by adjusting the observation images 630-1 and 630-2 to have the same size, based on the sizes set by the size determining section 340, and outputs the observation images 640-1 and 640-2 to the display apparatus 140 along with the raw images 600-1 and 600-2.

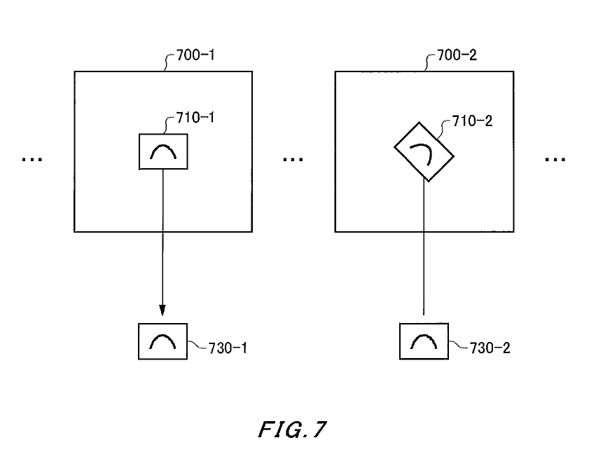

FIG. 7 shows other exemplary settings for the extraction ranges. The target location in the raw image 700-2 is slanted with respect to the target location in the raw image 700-1. The change over time in the inclination of the target location image can be caused by the target location rotating around the optical axis of the objective lens 125, for example. The orientation determining section 350 sets the orientation of the extraction frame 710-2 in the raw image 700-2 to be diagonal to the orientation of the extraction frame 710-1 set for the raw image 700-1, based on the rotational angle identified by the angle identifying section 310.

The extracting section 230 extracts the region in the extraction frame 710-1 from the raw image 700-1 to generate the observation image 730-1. The extracting section 230 extracts the region in the extraction frame 710-2 from the raw image 700-2 to generate the observation image 730-2. The display control section 242 adjusts the observation images 730-1 and 730-2 to have the same orientation, based on the orientations determined by the orientation determining section 350, and outputs the resulting images to the display apparatus 140 along with the raw images 700-1 and 700-2. As a result, the observer can view video of the target location with a fixed orientation.

When the center of the target location also shifts in a plane perpendicular to the optical axis, the position determining section 330 may determine the extraction frame 710-2 with a shifted position based on the position of the target location identified by the position identifying section 300. When the position of the target location shifts in the direction of the optical axis, the position determining section 330 may determine the extraction frame 710-2 with an adjusted size based on the position of the target location identified by the position identifying section 300.

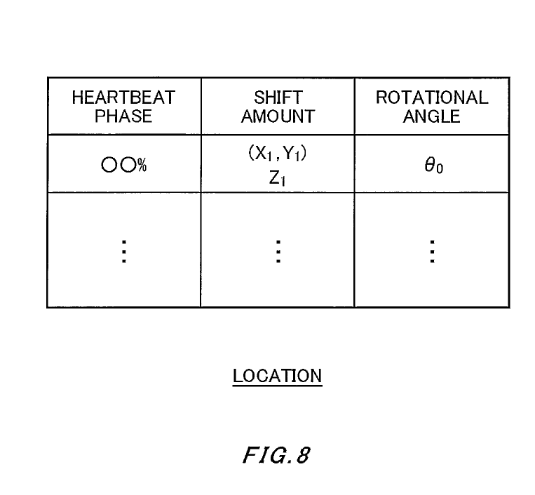

FIG. 8 shows an exemplary table of movement characteristics stored by the movement characteristic storage section 280. The movement characteristic storage section 280 stores shift amounts and rotational angles for each location, in association with the phase of the heart beat. The heart beat phase may be a value obtained by dividing time passed after a T wave by the period of the heart beat. The shift amount may be a shift amount (X, Y) in the plane perpendicular to the optical axis of the objective lens 125 and a shift amount (Z) in the direction of the optical axis of the objective lens 125. The shift amount may be a positional skew amount with respect to the position at the timing of the T wave. The rotational angle may be angular skew with respect to the angle at the time of the T wave.

The movement detecting section 210 can determine the heart beat phase in real time, based on the electrocardiographic signal acquired from the analyte information detector 130. For example, the movement detecting section 210 may determine the heart beat phase based on the heart beat period and the time that has passed since the timing of the T wave. The most recent heart beat period can be used as the current heart beat period. As another example, an average value of the heart beat period within a prescribed interval may be used as the current heart beat period. The movement detecting section 210 may determine the heart beat phase based on the waveform of the electrocardiographic signal. The movement detecting section 210 supplies the range setting section 220 with the determined heart beat phase.

In the range setting section 220, the position identifying section 300 can identify the positional shift amount of an identified location, based on the shift amount stored in the movement characteristic storage section 280 in association with the heart beat phase supplied from the movement detecting section 210. The angle identifying section 310 can identify the rotational angle of an identified location, based on the rotational angle stored in the movement characteristic storage section 280 in association with the heart beat phase supplied from the movement detecting section 210. The range determining section 320 can determine the position, size, and orientation of the extraction frames.

The movement characteristic storage section 280 can store the movement characteristics described in relation to FIG. 8 for each of a plurality of locations. As a result, the range setting section 220 can flexibly set extraction frames for each location designated as a target location for form observation or function observation.

The movement characteristic storage section 280 may acquire in advance displacement information that includes the shift amount and rotational angle of each location, along with the organism information signal from the analyte information detector 130, and store this information. The displacement information can be acquired in advance from a plurality of images captured in advance by the image capturing section 124, using image analysis such as object extraction, for example. The distance to each location can be acquired in advance using laser ranging.

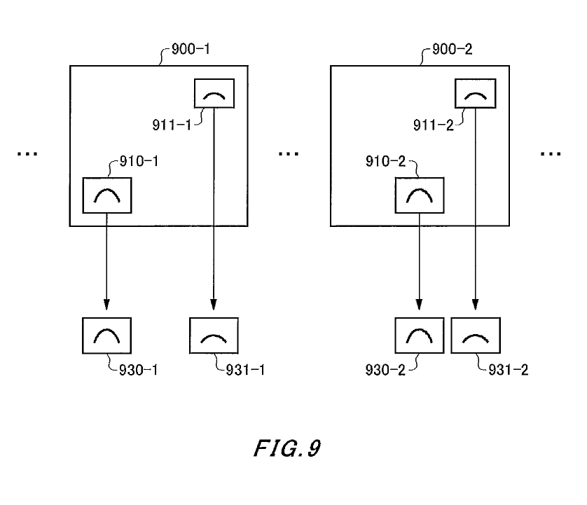

FIG. 9 shows an exemplary process for extracting a plurality of observation images from a single raw image. Here, the region identifying section 260 identifies a plurality of regions to be extracted from each raw image. For example, the observer may have designated a plurality of target locations to be extracted as observation images from one raw image. The range setting section 220 sets, in the raw image 900-1, an extraction frame 910-1 to include a first target location and an extraction frame 911-1 to include a second target location.

In the raw image 900-2 captured thereafter, the range setting section 220 sets, in the raw image 900-2, an extraction frame 910-2 to include the first target location and an extraction frame 911-2 to include the second target location, based on the electrocardiographic signal. When setting the extraction frames 910-1 and 910-2, the range setting section 220 determines the position, size, and orientation of each extraction frame based on the electrocardiographic signal at the image capturing timing of the raw image 900 and the movement characteristics of the corresponding target location stored in the movement characteristic storage section 280.

The extracting section 230 generates an observation image 930-1 by extracting the image in the extraction frame 910-1 of the raw image 900-1. The extracting section 230 generates an observation image 931-1 by extracting the image in the extraction frame 911-1 of the raw image 900-1. The extracting section 230 generates an observation image 930-2 by extracting the image in the extraction frame 910-2 of the raw image 900-2. The extracting section 230 generates an observation image 931-2 by extracting the image in the extraction frame 911-2 of the raw image 900-2. The display control section 242 outputs the observation images 930-1 and 931-1 to the display apparatus 140, in association with the raw image 900-1. The display control section 242 outputs the observation images 930-2 and 931-2 to the display apparatus 140, in association with the raw image 900-2.

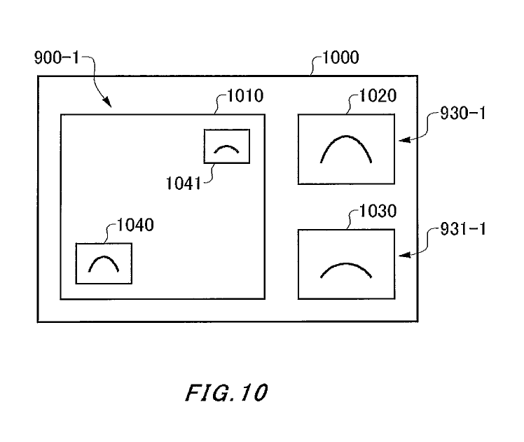

FIG. 10 shows another exemplary screen of the display apparatus 140. The display control section 242 sequentially switches the display in the display area 1010 on the screen 1000 of the display apparatus 140 between the raw images 900. The display control section 242 sequentially switches the display in the display area 1020 on the screen 1000 of the display apparatus 140 between the observation images 930. The display control section 242 sequentially switches the display in the display area 1030 on the screen 1000 of the display apparatus 140 between the observation images 931. As a result, the observer can view a plurality of locations in parallel.

The display control section 242 superimposes a mark 1040, which shows the extraction frame 910-1 of the raw image 900-1, on the raw image 900-1 displayed in the display apparatus 140. The display control section 242 also superimposes a mark 1041, which shows the extraction frame 911-1 of the raw image 900-1, on the raw image 900-1 displayed in the display apparatus 140. In this case, the display control section 242 may superimpose the marks 1040 and 1041 on the raw image 900-1 with different colors. For example, the mark 1040 may be a first color predetermined for the display area 1020, and the mark 1041 may be a second color predetermined for the display area 1030. The display control section 242 may superimpose an outline that is the same color as the mark 1040 in the display area 1020 as the outline of the observation image 930-1. The display control section 242 may superimpose an outline that is the same color as the mark 1041 in the display area 1020 as the outline of the observation image 931-1. As a result, the observer can easily recognize, in a single glance at the display apparatus 140, which location the images displayed in the display area 1020 correspond to.

FIGS. 5 and 10 show display states in which a plurality of images are displayed in a single display screen. As another display state example, the display control section 242 may respectively display the raw images, observation images, and fluorescent observation images in a display for raw images, a display for observation images, and a display for fluorescent observation images.

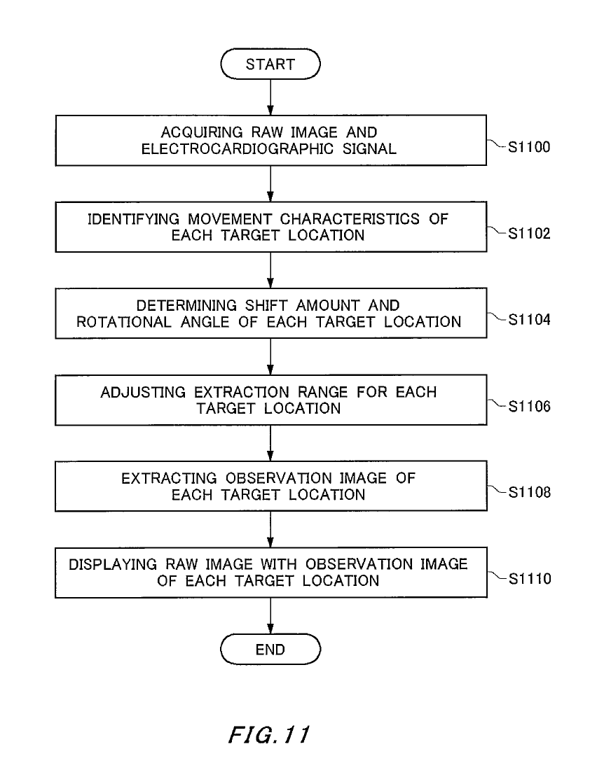

FIG. 11 shows a process flow of the endoscope apparatus 10. At S1100, the image generating section 200 acquires a raw image from the image capturing section 124. Furthermore, the movement detecting section 210 acquires the electrocardiographic signal from the analyte information detector 130 and calculates the heart beat phase based on the electrocardiographic signal. At S1102, the range setting section 220 identifies the movement characteristics of each target location based on the heart beat phase.

At S1104, in the range setting section 220, the position identifying section 300 determines the shift amount of each target location, and the angle identifying section 310 determines the rotational angle of each target location. At S 1106, the position determining section 330, the size determining section 340, and the orientation determining section 350 respectively determine the position, size, and orientation of the extraction frame for each target location. As a result, the extraction range is adjusted for each target location.

At S1108, the extracting section 230 extracts the region in each extraction range set at S1106 from the raw image acquired at S1100. As a result, an observation image for each target location is generated. At S1110, the display control section 242 supplies the display apparatus 140 with the raw image and the observation image for each target location, and the display apparatus 140 displays the received images.

FIG. 11 shows a process performed by the endoscope apparatus 10 from acquiring one raw image to extracting the observation images. By repeating this process for a plurality of raw images, a video of the raw images and a video of the observation images can be displayed on the display apparatus 140.

FIG. 11 describes an exemplary flow in which the images are displayed on the display apparatus 140, but when storing the images in the recording apparatus 150, the storage control section 244 may supply the recording apparatus 150 with a raw moving image that contains the raw images, to be stored therein. The storage control section 244 may compress the raw images using MPEG encoding or the like. In this case, the storage control section 244 may compress the raw images in modality units. Specifically, the storage control section 244 may compress a first modality moving image that includes the raw images captured using visible light and store the compressed moving image in the recording apparatus 150. Furthermore, the storage control section 244 may compress a second modality moving image that includes the raw images captured using fluorescent light and store the compressed moving image in the recording apparatus 150. By performing compression for each modality, the compression rate of the moving images can be increased.

If the irradiation light switches between the illumination light and the excitation light such that image capturing switches between visible light images and fluorescent light images over time, there is a skew between the image capturing timings of the visible light images and the fluorescent light images. In this case, the storage control section 244 may attach timing information for each of the first modality moving image and the second modality moving image. As a result, when the display apparatus 140 displays the first modality image and the second modality image, the display timing of each frame of the first modality moving image and the second modality moving image can be synchronized with the image capturing timing, based on the attached timing information.

The storage control section 244 may attach information identifying the extraction ranges to the raw moving image, and store the result in the recording apparatus 150. The information identifying the extraction ranges may be information concerning the positions, sizes, or orientations of the extraction frames, for example. The display apparatus 140 uses the extraction range information attached to the raw moving image to extract the observation images from the raw images, and displays the observation images together with the raw images. The storage control section 244 may compress the image regions set as extraction regions with a lower compression rate than other image regions. For example, the storage control section 244 may compress the image regions within the extraction ranges using intra coding, while compressing the image regions outside the extraction regions using inter coding. The storage control section 244 may compress only the image regions outside the extraction ranges and not compress the image regions in the extraction ranges.

The storage control section 244 may store the observation images as a moving image for observation in the recording apparatus 150. In this case, the storage control section 244 may generate a plurality of observation images for each target location, and store the resulting moving images for observation in the recording apparatus 150 for each target location. The storage control section 244 may attach information indicating an association between the raw moving image and the moving image for observation to at least one of the raw moving image and the moving image for observation, and store the resulting moving images in the recording apparatus 150.

In the above embodiments, visible light images or fluorescent light images are used as the images for form observation or function observation. Narrow-band light images may also be used as the images for form observation or function observation. The narrow-band light images may be obtained by irradiating the analyte 20 with light in a wavelength region narrower than the wavelength region of the illumination light. The wavelength region narrower than the wavelength region of the illumination light may be a blue wavelength region narrower than the blue wavelength region in the illumination light. As other examples, the wavelength region narrower than the wavelength region of the illumination light may be a green wavelength region narrower than the green wavelength region in the illumination light or a red wavelength region narrower than the red wavelength region in the illumination light.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. An endoscope apparatus that simultaneously displays a plurality of observation images, which are images for form observation or function observation of an organism, the endoscope apparatus comprising:
an image capturing section that captures a series of raw images, which are images of the organism;
a movement detecting section that detects movement of the organism;
a range setting section that sets ranges for extracting portions of the raw images respectively as the observation images, according to the movement of the organism detected by the movement detecting section;
an extracting section that extracts images of the ranges set by the range setting section respectively from the raw images; and
a display control section that displays the raw images together with the observation images extracted respectively therefrom.

2. The endoscope apparatus according to claim 1, wherein
the range setting section sets at least one of a position, a size, and an orientation of each image region extracted as an observation image, according to the movement of the organism detected by the movement detecting section.

3. The endoscope apparatus according to claim 1, wherein the range setting section includes:
a position identifying section that identifies a position of a target location for the form observation or the function observation in image regions captured by the image capturing section, based on the movement of the organism; and
a range determining section that determines the ranges to be extracted as the observation images based on the position identified by the position identifying section.

4. The endoscope apparatus according to claim 3, wherein
the position identifying section identifies a position of the target location in a plane orthogonal to an image capturing direction of the image capturing section, based on the movement of the organism, and
the range determining section includes a position determining section that determines a position of each image region to be extracted as an observation image, based on the position identified by the position identifying section.

5. The endoscope apparatus according to claim 3, wherein
the position identifying section identifies a position of the target location in an image capturing direction of the image capturing section, based on the movement of the organism, and
the range determining section includes a size determining section that determines a size of each image region to be extracted as an observation image, based on the position identified by the position identifying section.

6. The endoscope apparatus according to claim 1, wherein the range setting section includes:
an angle identifying section that identifies an angle of rotation, around an image capturing direction of the image capturing section, of the target location for the form observation or the function observation; and
an orientation determining section that determines an orientation of each image region to be extracted as an observation image, based on the angle identified by the angle identifying section.

7. The endoscope apparatus according to claim 1, further comprising a selection control section that selects which parameter, from among a position, a size, and an orientation of each image region to be extracted as an observation image, is to be used for setting the range of extraction by the range setting section, based on instructions from a user, wherein
the range setting section sets each range to be extracted as an observation image using the parameter or parameters selected by the selection control section.

8. The endoscope apparatus according to claim 1, wherein
the display control section displays the observation images to be larger than the image regions in the raw images extracted as the observation images.

9. The endoscope apparatus according to claim 1, wherein
the display control section displays each raw image with a mark indicating the range extracted as the observation image superimposed thereon.

10. The endoscope apparatus according to claim 1, further comprising a region identifying section that identifies a region in at least one of the raw images to be included in a range extracted as an observation image, wherein
the range setting section identifies a region in each raw image that corresponds to the region identified by the region identifying section, based on the movement of the organism detected by the movement detecting section, and sets each range to be extracted as an observation image to be a range that includes at least the identified region.

11. The endoscope apparatus according to claim 10, wherein
the region identifying section identifies the region in at least one of the raw images to be included in a range extracted as an observation image, based on instructions from a user.

12. The endoscope apparatus according to claim 10, further comprising a condition storage section that stores conditions that must be satisfied by an image of the target location for the form observation or the function observation, wherein
the region identifying section identifies, as the region to be included in the range to be extracted as the observation image, a region in at least one of the raw images that satisfies the conditions stored in the condition storage section.

13. The endoscope apparatus according to claim 1, wherein
the movement detecting section detects a phase of periodic movement of the organism, and
the range setting section sets the range to be extracted as the observation image according to the phase of the movement of the organism detected by the movement detecting section.

14. The endoscope apparatus according to claim 1, further comprising a movement characteristic storage section that stores movement characteristics in each of a plurality of regions captured by the image capturing section, in association with a phase of the movement of the organism, wherein
the range setting section identifies movement of a target location for the form observation or the function observation, based on the phase of the movement of the organism detected by the movement detecting section and the movement characteristics stored in the movement characteristic storage section, and sets each range to be extracted as an observation image according to the identified movement.

15. The endoscope apparatus according to claim 14, wherein
the range setting section identifies movement of each of a plurality of the target locations, based on the phase of the movement of the organism detected by the movement detecting section and the movement characteristics stored in the movement characteristic storage section, and sets a plurality of ranges to be extracted as observation images for each raw image,
the extracting section extracts image regions of the plurality of ranges set by the range setting section from each raw image, and
the display control section displays each raw image together with the plurality of observation images extracted therefrom.

16. The endoscope apparatus according to claim 13, wherein
the movement detecting section detects a phase of a heart beat of the organism, and
the range setting section sets the ranges to be extracted as the observation images according to the phase of the heart beat.

17. A method for simultaneously displaying a plurality of observation images, which are images for form observation or function observation of an organism, the method comprising:
detecting movement of the organism;
setting ranges for extracting portions of a plurality of raw images, which are obtained by capturing images of the organism, respectively as the observation images, according to the movement of the organism;
extracting images of the set ranges respectively from the raw images; and
displaying the raw images together with the observation images extracted respectively therefrom.

18. A computer readable medium storing thereon a program for use by an endoscope apparatus that simultaneously displays a plurality of observation images, which are images for form observation or function observation of an organism, the program causing a computer to function as:
a movement detecting section that detects movement of the organism;
a range setting section that sets ranges for extracting portions of a plurality of raw images, which are obtained by capturing images of the organism, respectively as the observation images, according to the movement of the organism detected by the movement detecting section;
an extracting section that extracts images of the ranges set by the range setting section respectively from the raw images; and
a display control section that displays the raw images together with the observation images extracted respectively therefrom.
